(19) United States
(12) Patent Application Publication
(10) Pub. No.: US 2013/0010391 A1
(43) Pub. Date: Jan. 10, 2013

(54) THERMAL FLYING HEIGHT CONTROL SLIDER WITH SLIT IN HARD DISK DRIVER

(75) Inventors: Hui Li, Singapore (SG); Nobutoshi Sagawa, Singapore (SG); Kyosuke Ono, Tokyo (JP)

(73) Assignee: Hitachi Asia Ltd., Singapore (SG)

(21) Appl. No.: 13/177,043

(22) Filed: Jul. 6, 2011

(51) Int. Cl. G11B 5/60

(52) U.S. Cl. 360/235.4; 360/234.3; G9B/5.229

(57) ABSTRACT

A slider includes a void for controlling the flying height of the slider over a disk in a HDD. The slider comprises a slider body having a leading surface and a trailing surface. A read/write element is formed in a portion of the slider body proximate to the trailing surface of the slider body and a first thermal heater proximate the read/write element, wherein a first void is defined within the slider body proximate to the read/write element for increasing a mobility of the read/write element to increase the protrusion when thermal energy is introduced to the read/write element.

### FIELD OF THE INVENTION

This invention relates to a Hard Disk Drive (HDD). More particularly, this invention relates to a slider that includes a read/write element that is positioned over a disk to read and write data. Still more particularly, this invention relates to a slider that includes a thermal heater and a void for controlling the flying height of the read/write element over a disk in a HDD.

### BACKGROUND

Today's electronic devices require storage devices that are smaller in size with greater storage capacities. To increase storage capacity, the recording densities of hard disk drives have been increased. This leads to significant decrease in the slider-disk spacing to less than 10 nm for increasing recording densities. However, those skilled in the art would like to further reduce flying height of a read/write element in the slider to prevent read and write faults from occurring and to improve the efficiency and accuracy of read and write operation.

To reduce the flying height of a read/write element, those skilled in the art have proposed to use a small resistance heater incorporated into the slider near the read/write element. By applying electrical current to the heater, the material around the resistance heater expands due to the thermal energy imparted to the material by the heater. The expansion of the material may be used to change the contour of a portion of the slider or to form a protrusion from the flying surface of the slider to reduce the flying height of the read/write element. Those skilled in the art are constantly trying to improve the power efficiency and maximize the reduction of the flying height provided by such small resistance heaters. However, the use of these resistance heaters in the slider is limited as the amount of thermal energy that can be introduced in the slider head is restricted to a certain amount so as not to cause over heating or malfunction of the read/write element.

Thus, those skilled in the art are constantly striving to design a configuration of a slider body that further improves the reduction in flying height of the read/write element to improve the efficiency and accuracy of read and write operation.

### SUMMARY OF THE INVENTION

The above and other problems are solved and an advance in the art is made by a void in the slider head in accordance with this invention. A first advantage of this invention is that the use of the void with a thermal heater reduces the flying height of a read/write element over a rotating disk while read and/or write operations are being performed. A second advantage of this invention is that the slider can be easily fabricated since only a small portion of the material is removed to form the void. A third advantage of this invention is that it can be used for future 10 Tb/inch2 areal density magnetic recording.

In accordance with embodiments of this invention, a slider for an HDD is configured in the following manner. The slider includes a slider body. The slider body has a leading surface and a trailing surface. A read/write element is formed in a portion of the slider body proximate to the trailing surface of the slider body. A first thermal heater is formed proximate to the read/write element. A first void is defined within the slider body proximate to the read/write element. The first void increases a mobility of the read/write element to increase a protrusion from an air bearing surface of the slider body resulting from thermal energy being introduced to material proximate to the read/write element. In other embodiments, a distance between the first void and the first thermal heater is predetermined relative to a desired flying height reduction. In still other embodiments, a distance between the first void and the air bearing surface of the slider body is predetermined relative to a desired flying height reduction. In still other embodiments, the first void has a certain thickness relative to a desired flying height reduction.

In accordance with some embodiments of this invention, the first void is elongated in shape to increase mobility along a longitudinal plane of the read/write element. The slider assembly further includes a basecoat and a substrate. In some other embodiments, the first thermal heater is within the basecoat and first void is defined within the substrate.

In accordance with some embodiments of this invention, the first thermal heater is located between the read/write element and an edge of the basecoat proximate to the substrate and the first void is defined within the substrate proximate to the edge of the basecoat.

In accordance with some embodiments of this invention, a second void is defined in the basecoat proximate to the read/write element and the trailing surface. Preferably, the second void is elongated in shape.

In accordance with some embodiments of this invention, the slider assembly further includes a second thermal heater between the read/write element and the second void. In other embodiments, the second void has a certain thickness relative to a desired flying height reduction. In still other embodiments, a distance between the second void and the second thermal heater is predetermined relative to a desired flying height reduction. In other embodiments, a distance between the second void and the air bearing surface of the slider body is predetermined relative to a desired flying height reduction.

In accordance with embodiments of this invention, a method of controlling a flying height of a slider over a storage media is performed in the following manner. An electrical current is applied to a first thermal heater on a first side of a read/write element formed in a portion of a slider body proximate to a trailing surface of said slider body. Thermal energy is generated in the first thermal heater responsive to the electrical current being applied. Thermal energy is then directed towards the read/write element to cause the read/write element to expand. A protrusion is formed from the air bearing surface of the slider body that includes a portion of the read/write element to reduce a flying height of the read/write element over a rotating disk. The slider body includes a first void defined within the slider body proximate to the read/write element that increases a mobility of the read/write element. The first void further prevents thermal energy from flowing away from the read/write element and directs the thermal energy towards the read/write element.

In some embodiments of this invention, the method further applies an electrical current to a second thermal heater on a second side of the read/write element formed in a portion of the slider body proximate to the trailing surface of the slider body. Thermal energy is generated in the second thermal heater responsive to the electrical current being applied. Thermal energy generated by the second thermal heater is then directed towards the read/write element to cause the read/write element to expand. A further protrusion is formed from the air bearing surface of the slider body that includes a portion of the read/write element to reduce a flying height of the read/write element over a rotating disk, wherein the slider body includes a second void defined within the slider body proximate to the read/write element for increasing a mobility of the read/write element. The second void further prevents thermal energy from flowing away from the read/write element and directs the thermal energy towards the read/write element. Preferably, first and second voids are elongated in shape to cause said read/write element to expands linearly and moves towards an air bearing surface of slider body.

### BRIEF DESCRIPTION OF THE DRAWINGS

The above and other features and advantages of this invention are described in the

Detailed Description set forth below and illustrated in the following drawings:

FIG. 1 illustrating components of a HDD including a slider configured in accordance with invention;

FIG. 2 illustrating a slider in accordance with an embodiment of this invention;

FIG. 3 illustrating a cross sectional view of a slider body of a slider along plane A shown in FIG. 2;

FIG. 4 illustrating a configuration in a basecoat of a slider body in accordance with an embodiment of this invention;

FIG. 5 illustrating a configuration in a basecoat of a slider body in accordance with an embodiment of this invention;

FIG. 6 illustrating a configuration in a slider body in accordance with an embodiment of this invention;

FIG. 7 illustrating a configuration in a slider body in accordance with an embodiment of this invention;

FIG. 8 illustrating the amount of protrusion under 3 different configurations of the slider body in accordance with an embodiment of this invention;

FIG. 9 illustrating the flying height reduction under 3 different configurations of the slider body in accordance with an embodiment of this invention;

FIG. 10 illustrating the dimensions of a void in accordance with an embodiment of this invention;

FIG. 11 illustrating the effects to a protrusion when distance of void to bottom surface or air bearing surface, is varied in accordance with an embodiment of this invention;

FIG. 12 illustrating the effects to the protrusion when distance of between a void to a thermal heater, is varied in accordance with an embodiment of this invention; and

FIG. 13 illustrating the effects to the protrusion when the thickness of the void, is varied in accordance with an embodiment of this invention.

### DETAILED DESCRIPTION

This invention relates to a Hard Disk Drive (HDD). More particularly, this invention relates to a slider that includes a read/write element that is positioned over a disk to read and write data. Still more particularly, this invention relates to a slider that includes a thermal heater and a void for controlling the flying height of the read/write element over a disk in a HDD.

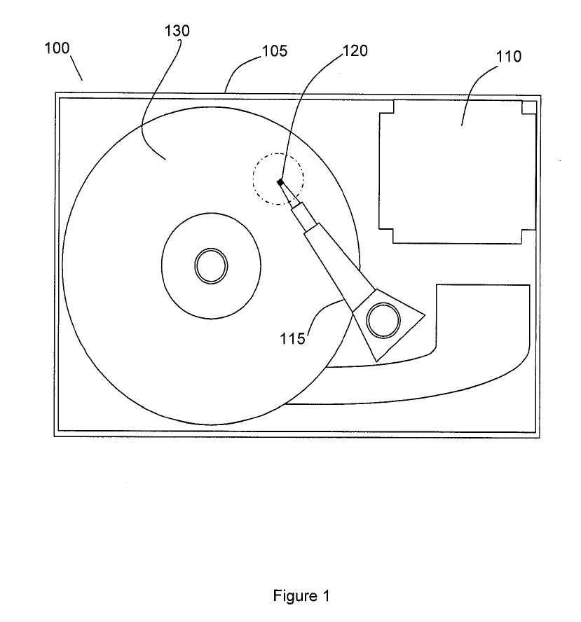

FIG. 1 illustrates HDD 100 that incorporates a slider head in accordance with an embodiment of this invention. HDD 100 is enclosed in housing 105. Inside housing 105, disk 130 made of a media that data may be written to and read from is mounted on a rotating platform (Not Shown). Slider 120 includes read and/or write heads for writing data to and reading data from disk 130. Articulated arm 115 is positioned over disk 130 and has slider 120 affixed to a free end of articulated arm 115 and is movable to place slider 120 in certain position over disk 130 to read data from or write data to a particular track of disk 130. Electronics 110 include all of the circuitry for controlling the process of reading data from and writing data to disk 130. In particular, electronics 110 include the circuitry for controlling the motor (Not Shown) for rotating disk 130; circuitry for positioning slider 120 in the proper position over disk 130 by articulating arm 115; circuitry for controlling slider 120; and circuitry to control the thermal heaters which will be discussed below. One skilled in the art will recognize that only those components of HDD 100 that are needed to understand the invention are described. A complete description of HDD 100 is omitted for brevity.

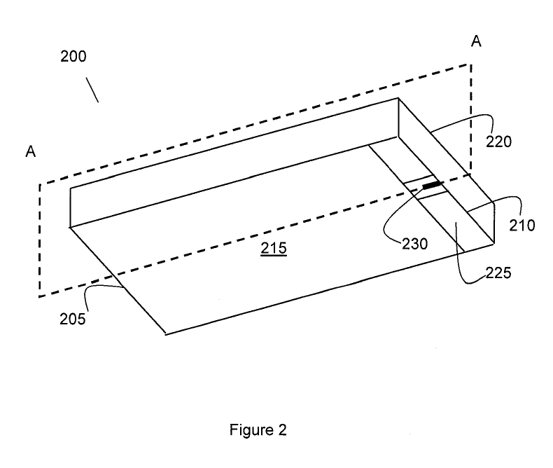

FIG. 2 is an enlarged perspective view of slider 120. Preferably, slider includes slider body 200 having a trailing surface 210 at one end of slider body 200 that faces away from the oncoming of rotation disk 130. Slider body 200 further includes leading surface 205 that faces the oncoming rotation of disk 130, top surface 220, and bottom or Air Bearing surface 215. Slider 120 is a structure formed by depositions of layers of material with base layers formed proximate to leading surface 205 and the top layer formed proximate to trailing surface 210.

Slider body 200 also includes portion 225 proximate to trailing surface 210 that includes read/write element 230 that is a structure formed within portion 225. One skilled in the art will note that only one read/write element 230 is included in portion 225 in this embodiment of the invention. However, more than one read/write element may be formed within section 225 without departing from this invention.

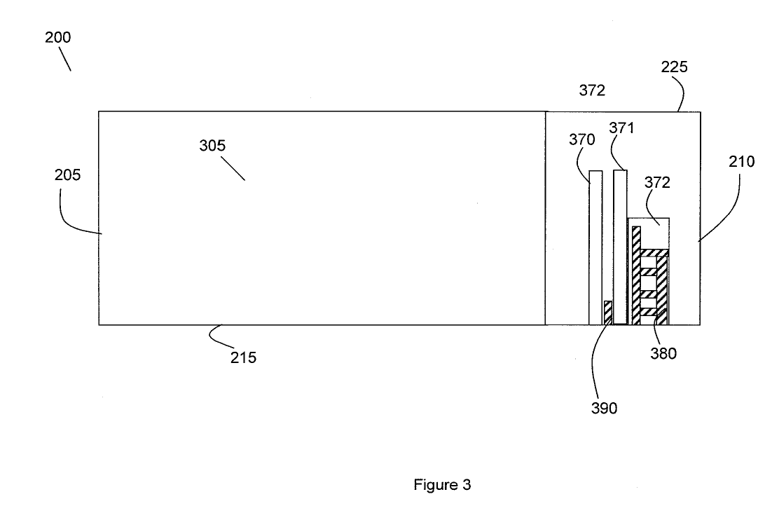

FIG. 3 illustrates a cross sectional view of slider body 200 of slider 120 along plane A shown in FIG. 2. Slider body 200 includes substrate 305 formed proximate to leading surface 205. Preferably, substrate 305 is a layer of Al2O3-TiC. However, one skilled in the art will recognize that any common substrate material may be used without departing from this invention. Portion 225 also known as the basecoat is then formed over layer substrate 305. Preferably, basecoat 225 is Al₂O₃. However, one skilled in the art will recognize that any common basecoat material may be used without departing from this invention.

Slider body 200 includes read/write element 230 formed within basecoat 225. Read/write element 230 includes structures formed in basecoat 225. The structures include first shield 370, second shield 371, pole 372, read head 390 and write coils 380. Preferably, first shield 370, second shield 371, and pole 372 are structures formed in basecoat 225 proximate to bottom surface 215. However, other configurations may be used without departing from this invention. Preferably first shield 370, second shield 371, and pole 372 are Ni-Fe material as is common in the art. Write coils 380 are also formed proximate to bottom surface 215 in basecoat 225 and are preferably made of Copper (Cu). Read head 390 is also formed proximate to bottom surface 215 in basecoat 225 and is preferably a magnetoresistive layer to provide magnetic bias. Read/write element 230 may be configured in the following manner. First shield 370 is at a first end of the read/write element 230 while pole 372 is at a second end of the read/write element 230. Read head 390 is between first shield 370 and second shield 371 while write coils 380 are formed within pole 372. One skilled in the art will recognize that there are other possible configurations and the exact configuration is left to one skilled in the art.

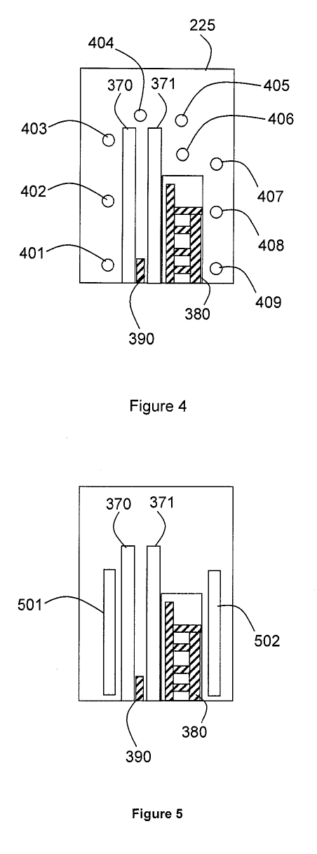

FIG. 4 illustrates a configuration in the basecoat in accordance with an embodiment of this invention. Voids 401-409 are formed around read/write element 230. Specifically, voids 401-409 are empty spaces or air pockets. One skilled in the art will recognize that although voids 401-409 are shown as circular or spherical in FIG. 4, voids 401-409 may be any shape without departing from this invention. In accordance with the shown embodiment, voids 401-409 reduce the mechanical constraints of the materials in the basecoat. In particular, the integrity of the material surrounding read/write element 230 is reduced. The reduction in the integrity of the material, in turn, increases the mobility of the read/write element 230. Hence, when thermal energy is introduced by write coils 380 or a thermal heater, read/write element 230 expands and is movable relative to the remainder of the basecoat.

In accordance with another embodiment of this invention shown in FIG. 5, elongated voids 501 and 502 are introduced substantially parallel to a longitudinal axis of the read/write element 230. The elongated shape of voids 501 and 502 improves the expansion of read/write element 230 along the longitudinal axis. The improved expansion along the longitudinal axis causes a greater protrusion from bottom surface 215 of slider body 200.

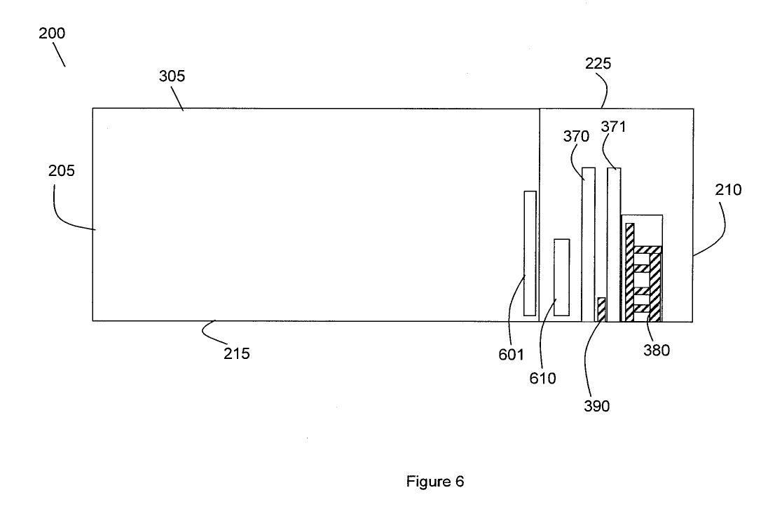

In accordance with yet another embodiment of this invention shown in FIG. 6, a first thermal heater 610 is formed in basecoat 225 and a first void 601 proximate to first thermal heater 610 in substrate 305 of slider body 200. First thermal heater 610 is formed proximate to bottom surface 215 on a first side of the read/write element 230. First thermal heater 610 is formed proximate to bottom surface 215 on the first side of the read/write element 230 in order to direct most of the thermal energy to the portion of read/write element 230 proximate to bottom surface 215. First void 601 is formed proximate to first thermal heater 610. First thermal heater 610 and first void 601 are adjacent to each other. First void 601 acts as an insulator and prevents thermal energy produced by first thermal heater 610 from being imparted towards leading end 205. Hence, first void 601 also directs thermal energy produced by first thermal heater 610 towards read/write element 230. Further, first void 601 reduces the mechanical constraints of the materials. In particular, the integrity of the material surrounding the read/write element 230 is reduced which increases the mobility of the read/write element 230. Further, first void 601 is elongated in shape. Thus, when thermal energy is introduced by first thermal heater 610, read/write element expands linearly and moves towards bottom surface 215 of slider body 200. One skilled in the art will recognize that although first void 601 is shown to form in substrate 225, first void 601 may also be formed inside basecoat 225 if there is enough space to be formed inside basecoat 225. First void 601 only needs to be adjacent to first thermal heater 610 to direct thermal energy produced by first thermal heater 610 towards read/write element 230 and reduce the mechanical constraints of the material to allow greater mobility of read/write element 230.

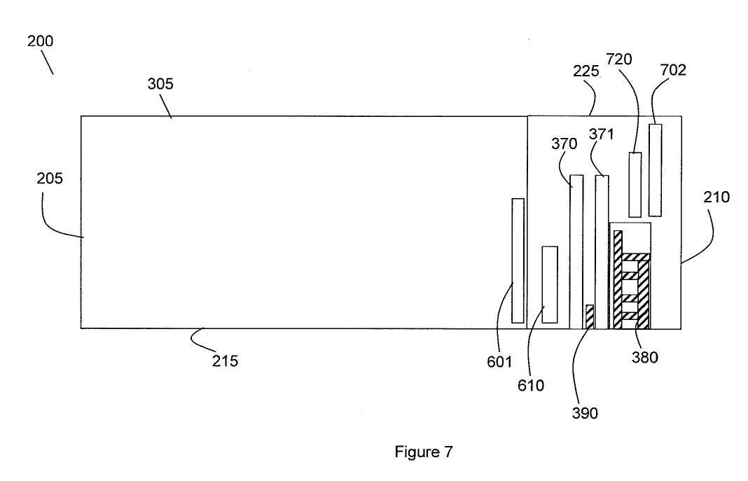

In accordance with yet another embodiment of this invention shown in FIG. 7, first thermal heater 610 and first void 601 are formed in the same manner as described with respect to FIG. 6. In addition, second thermal heater 720 and second void 702 are formed in basecoat 225. Second thermal heater 720 is formed at the other side of read/write element 230. Second thermal heater 720 causes more expansion proximate to write coils 380. One skilled in the art will recognize that second thermal heater 720 ideally causes more expansion of the read/write element when configured to be proximate to bottom surface 215. However, as the design of basecoat 225 is typically kept small, second thermal heater 720 may be configured to be above write coils 380 (As Shown) instead of being adjacent to write coils 380. In order to improve the overall performance of the read/write element, second void 702 is also formed adjacent to second thermal heater 720 to direct the thermal energy towards the read/write element 230 and reduce the mechanical constraints of the materials around the read/write element 230. One skilled in the art will recognize that the size of first thermal heater 610 and second thermal heater 720; first void 601 and second void 702 may be different without departing from this invention. Different sizes may be used in order to obtain a desirable amount of expansion. Hence, the size of each void and thermal heater is left as a design choice to those skilled in the art. One skilled in the art may also control the amount of thermal energy generated by first and second thermal heater by controlling the amount of electrical current applied to first and second thermal heater.

With reference to FIG. 7, in accordance with yet another embodiment of this invention, second thermal heater 720 is absent from the configuration as shown in FIG. 7. Accordingly, thermal energy produced by first thermal heater 610 and read/write element 230 are prevented from flowing away from the read/write element 230. Instead, thermal energy is trapped between first void 601 and second void 702 in which thermal energy are efficiently used to expand read/write element 230 and the surround materials. Further, as first void 601 and second void 702 reduce the mechanical constraints of the materials surrounding read/write element 230, a greater protrusion is formed surrounding read/write element 230 which in turn reduces the flying height of read/write element 230. One skilled in the art will recognize that second void ideally is more efficient in trapping thermal energy when configured to be proximate to bottom surface 215 and as close as possible to write coils 380. However, as the design of basecoat 225 is typically kept small, second void 702 may be configured to be above write coils 380 (As Shown) instead of being adjacent to write coils 380.

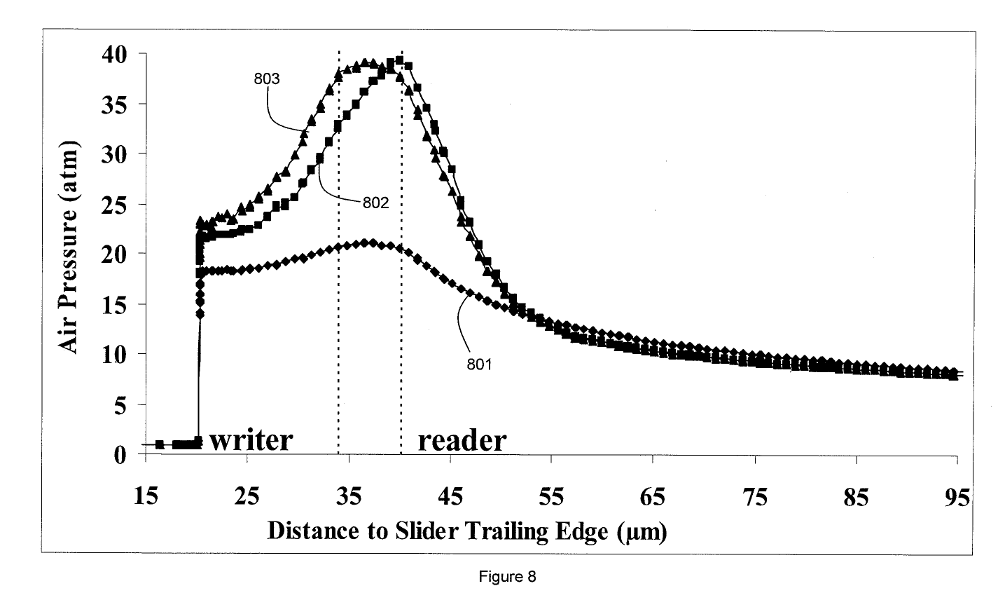

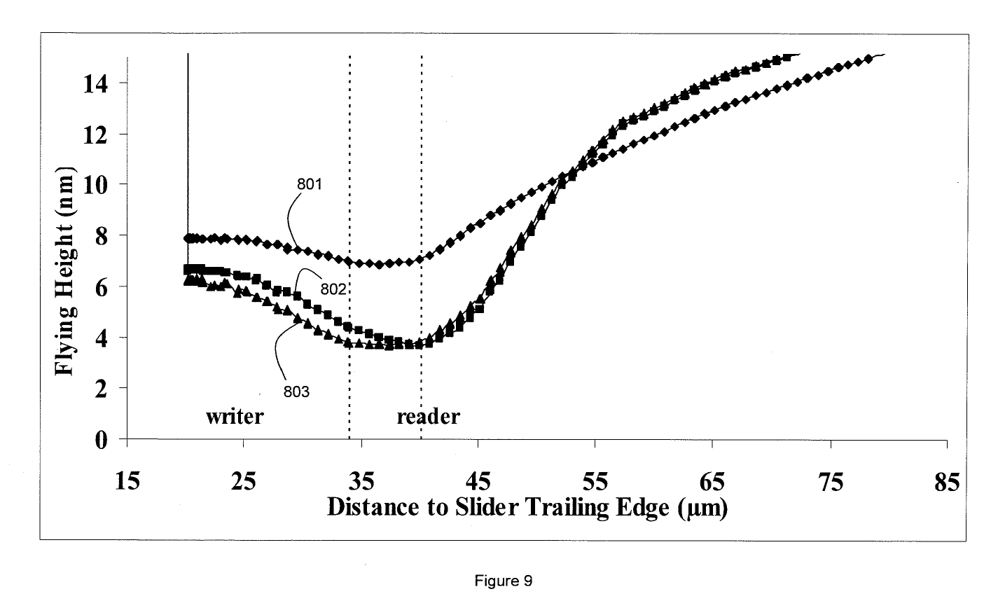

FIG. 8 illustrates the amount of protrusion under 3 different configurations of the slider body. Line 801 illustrates the protrusion profile of a first configuration with first thermal heater 610 but without first void 601. Line 802 illustrates the protrusion profile of a second configuration with first thermal heater 610 and first void 601 as shown in FIG. 6. Line 803 illustrates the protrusion profile of a third configuration with two thermal heaters and two voids as shown in FIG. 7. As shown in FIG. 8, the second and third configurations have a larger protrusion compared to the first configuration. More particularly, the protrusion profile of the second configuration is much sharper proximate to read head 390 while the protrusion profile of the third configuration is more uniform over read head 390 and write coils 380. In the second configuration, first void 601 is proximate to read head 390 and greatly reduces the mechanical constraints in the materials proximate to read head 390. Further, a greater concentration of thermal energy is directed to read head 390 due to first void performing as an insulator directing thermal energy towards read/write element 230. As for the third configuration, second void 702 and second thermal heater 720 induces more protrusion proximate to the write coils 380. Particularly, the third configuration provides a uniform protrusion when compared to the second configuration. Correspondingly, the second and third configurations achieve a lower flying height compared to the first configuration as shown in FIG. 9.

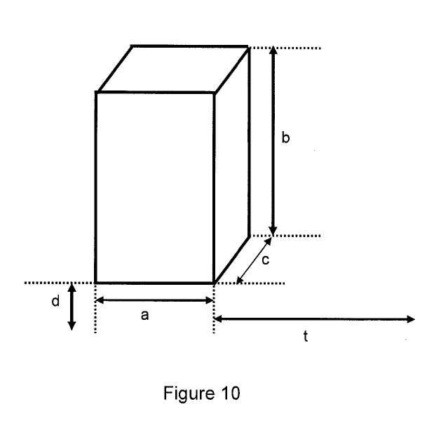

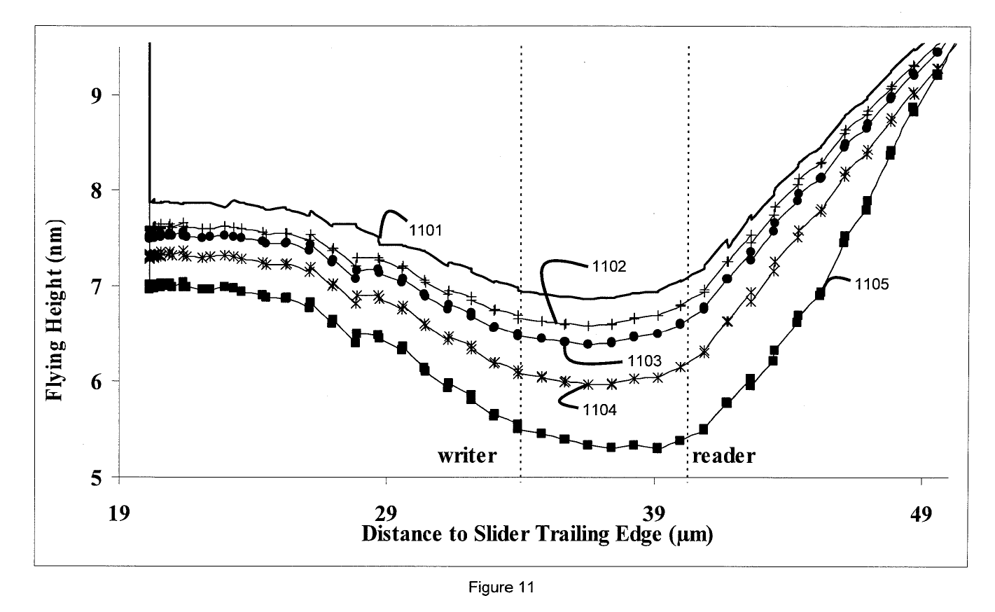

FIG. 10 illustrates the dimension of voids 601 and/or 702 in accordance with preferable embodiments of this invention. Voids 601 and 702 are in the shape of a rectangular box plate with dimension a, b and c. Voids 601 and 702 are typically proximate to thermal heaters 610 and 720. In order for the thermal heaters 610 and 720 to impart thermal energy to read/write element 230, first thermal heater 610 is preferably formed between first void 601 and read/write element 230 while second thermal heater 720 is preferably formed between second void 702 and read/write element 230. This is because voids 601 and 702 are empty spaces or air pockets and act as an insulator to prevent thermal energy from flowing away from read/write element 230. Specifically, voids 601 and 702 direct the thermal energy produced by thermal heaters 610 and 720 towards read/write element 230. The distance of voids 601 and 702 to air bearing surface (ABS) or bottom surface 215 is denoted as d. The distance of voids 601 and 702 to thermal heaters 610 and 720 is denoted as t.

With reference to the configuration in FIG. 6, FIG. 11 shows the effects to the protrusion when distance of void 601 to bottom surface 215, d, is varied. In particular, line 1101 shows a configuration without void 601, line 1102 shows a configuration with d fixed at 20 μm, line 1103 shows a configuration with d fixed at 15 μm, line 1104 shows a configuration with d fixed at 10 μm, and line 1105 shows a configuration with d fixed at 5 μm. As shown in FIG. 11, as d decreases, protrusion of read/write element increases. Hence, the lowest flying height is achieved when first void 601 is closer to bottom surface 215.

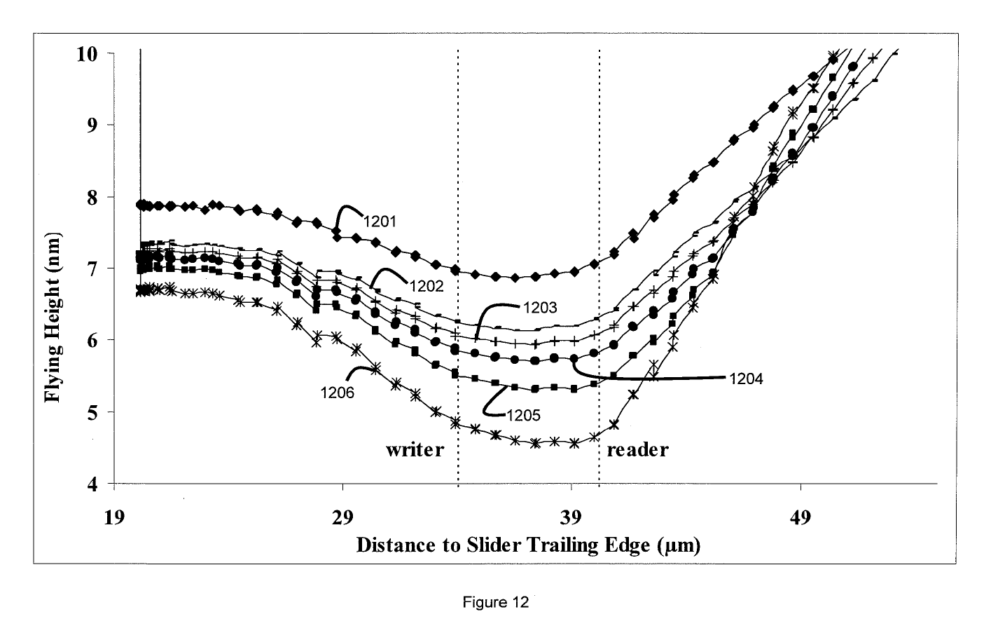

With reference to configuration in FIG. 6, FIG. 12 shows the effects to the protrusion when distance of first void 601 to thermal heater 610, t, is varied. In particular, line 1201 shows a configuration without first void 601, line 1202 shows a configuration with t fixed at 10 μm, line 1203 shows a configuration with t fixed at 7 μm, line 1204 shows a configuration with t fixed at 5 μm, line 1205 has t fixed at 3 μm, and line 1206 shows a configuration with t fixed at 1 μm. As shown in FIG. 12, as t decreases, protrusion of read/write element 230 increases. Hence, the lowest flying height is achieved when first void 601 is closer to first thermal heater 610.

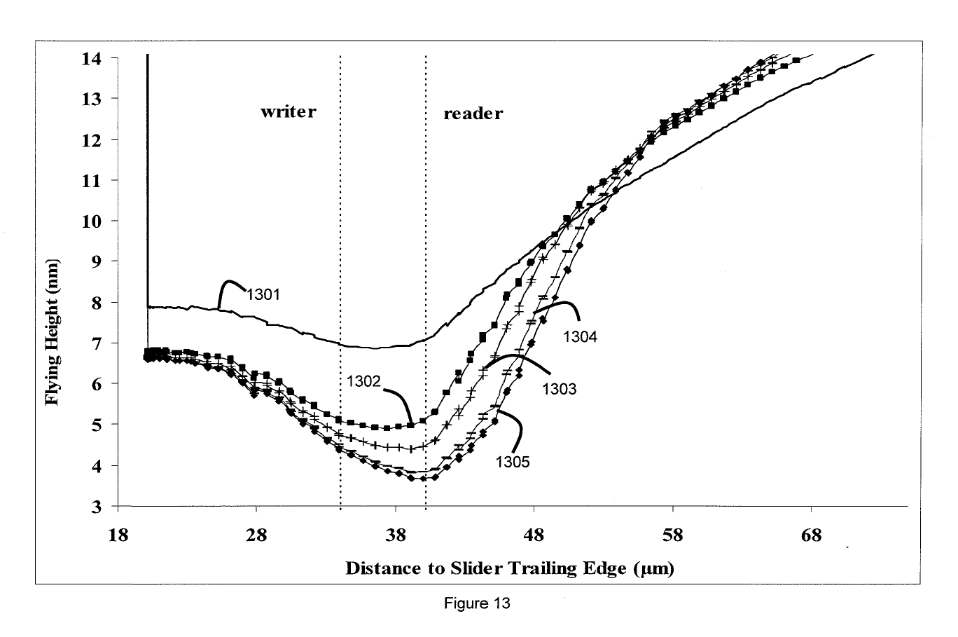

With reference to configuration in FIG. 6, FIG. 13 shows the effects to the protrusion when dimension a which is the thickness of void 601, is varied. In particular, line 1301 shows a configuration without first void 601, line 1302 shows a configuration with a fixed at 1 μm, line 1303 shows a configuration with a fixed at 4 μm, line 1304 shows a configuration with a fixed at 8 μm, and line 1305 shows a configuration with a fixed at 10 μm. As shown in FIG. 13, as a increases, protrusion of read/write element 230 increases. Hence, the lowest flying height is achieved when the thickness of first void 601 increases.

Based on FIGS. 11-13, it can be observed that the protrusion of read/write element 230 or the flying height can be controlled by varying the parameters a, d, and t. Further, protrusion of read/write element 230 is more sensitive at read head 390 compared to write coils 380. Nevertheless, one skilled in the art will recognize that adding a second void and a second thermal heater as shown in FIG. 7 may compensate or increase the protrusion at the write coils 380. Further, one skilled in the art will recognize that a desired protrusion at the read head 390 and write coils 380 can be obtained by varying the parameters a, d, and t of first void 601 and second void 702. The exact parameters of the voids are left to one skilled in the art.

The above is a description of embodiments of this invention. It is expected that those skilled in the art can and will design alternative embodiments that infringe this invention as set forth in the following claims.

Having described the invention, and a preferred embodiment thereof, we now claim, as new and secured by letters patent:

1. A slider configuration for controlling a flying height of a slider over a storage media, said slider configuration comprising:
a slider body having a leading surface and a trailing surface;
a read/write element formed in a portion of said slider body proximate to said trailing surface of said slider body; and
a first thermal heater proximate to said read/write element,
wherein a first void is defined within said slider body proximate to said read/write element for increasing a mobility of said read/write element to increase a protrusion from an air bearing surface of said slider body in response to thermal energy being introduced to material proximate to said read/write element.

2. The slider assembly of claim 1, wherein said first void is elongated in shape to increase mobility along a longitudinal plane of said read/write element.

3. The slider assembly of claim 2, wherein said slider body comprises:
a basecoat; and
a substrate.

4. The slider assembly of claim 3, wherein said first thermal heater is within said basecoat.

5. The slider assembly of claim 4, wherein said first void is defined within said substrate.

6. The slider assembly of claim 5, wherein said first thermal heater is located between said read/write element and an edge of said basecoat proximate to the substrate, and wherein said first void is defined within said substrate proximate to said edge of said basecoat.

7. The slider assembly of claim 2, wherein said basecoat further comprises a second void proximate to said read/write element and said trailing surface for increasing a mobility of said read/write element to increase a protrusion from said air bearing surface of said slider body in response to thermal energy being introduced to material proximate said read/write element.

8. The slider assembly of claim 7, wherein said second void is elongated in shape.

9. The slider assembly of claim 7, further comprising:
a second thermal heater between said read/write element and said second void.

10. The slider assembly of claim 9, wherein a distance between said second void and said second thermal heater is predetermined relative to a desired flying height reduction.

11. The slider assembly of claim 7, wherein each of said first and second voids have a certain thickness relative to a desired flying height reduction.

12. The slider assembly of claim 7, wherein a distance between said second void and said air bearing surface of said slider body is predetermined relative to a desired flying height reduction.

13. The slider assembly of claim 1, wherein a distance between said first void and said first thermal heater is predetermined relative to a desired flying height reduction.

14. The slider assembly of claim 1, wherein a distance between said first void and said air bearing surface of said slider body is predetermined relative to a desired flying height reduction.

15. A method of controlling a flying height of a slider over a storage media, said method comprising:
applying an electrical current to a first thermal heater on a first side of a read/write element formed in a portion of a slider body proximate to a trailing surface of said slider body;
generating thermal energy in said first thermal heater in response to said electrical current being applied;
directing said thermal energy towards said read/write element;
causing said read/write element to expand; and
forming a protrusion from said air bearing surface of said slider body that includes a portion of said read/write element to reduce a flying height of said read/write element over a rotating disk,
wherein said slider body includes a first void defined within said slider body proximate to said read/write element for increasing a mobility of said read/write element.

16. The method of claim 15, further comprising:
preventing said thermal energy from flowing away from said read/write element.

17. The method of claim 16, wherein said first void is elongated in shape to cause said read/write element to expand linearly and move towards an air bearing surface of the slider body.

18. The method of claim 17, further comprising:
applying an electrical current to a second thermal heater on a second side of said read/write element formed in a portion of said slider body proximate to said trailing surface of said slider body;
generating thermal energy in said second thermal heater in response to said electrical current being applied;
directing said thermal energy towards said read/write element;
causing said read/write element to expand; and
forming a protrusion from said air bearing surface,
wherein said slider body includes a second void defined within said slider body proximate to said read/write element and said trailing surface for increasing a mobility of said read/write element.

19. The method of claim 17, wherein said second void is elongated in shape to cause said read/write element to expand linearly and move towards an air bearing surface of slider body.
